(19) United States
(12) Patent Application Publication
(10) Pub. No.: US 2026/0320547 A1
(43) Pub. Date: Oct. 15, 2026

(54) LOCAL ADAPTIVE PROFILES FOR DISTRIBUTED DEVICES

(71) Applicant: Ivanti, Inc., South Jordan, UT (US)

(72) Inventors: Ian Hughes, Daresbury (GB); Travis Peters, South Jordan, UT (US); Taylor Sorensen, South Jordan, UT (US); Brady Bess, South Jordan, UT (US); Patrick Greenwald, South Jordan, UT (US)

(73) Assignee: Ivanti, Inc., South Jordan, UT (US)

(21) Appl. No.: 19/639,455

(22) Filed: Apr. 6, 2026

Related U.S. Application Data
(60) Provisional application No. 63/785,837, filed on Apr. 9, 2025.

(51) Int. Cl. G06Q 10/087

(52) U.S. Cl. CPC G06Q 10/087

(57) ABSTRACT

A method of profile-based large language model (LLM) processing in inventory management includes presenting, at a first device, a profile creation interface. The method includes receiving training information via the interface and collating it into an adaptive profile that directs output and decisions of an AI-based LLM of a second device having local LLM functionality. The profile is communicated to and stored at a cloud device for remote access. During inventory operations, the second device retrieves and implements the adaptive profile to modify operations of the local LLM engine. The second device receives image data depicting objects in an inventory management environment and processes it using the local LLM engine and the adaptive profile to determine a metric of the objects. An inventory data message is generated based on the processing, translated to a host system protocol, and communicated to the host system for integration into an inventory management database.

### CROSS REFERENCE TO RELATED APPLICATION

This application claims priority to and the benefit of U.S. Provisional Application No. 63/785,837, filed Apr. 9, 2025, which is incorporated herein by reference in its entirety.

### FIELD

The embodiments described in this disclosure are related to mobile device management and in particular, some embodiments relate to augmenting artificial intelligence engines using adaptive profiles in distributed devices.

### BACKGROUND

Distributed devices such as rugged devices and scanner devices may be implemented in warehouse environments and consumer environments to perform inventory management operations such as product and object tracking and inventory assessment. Some inventory management operations are implemented using telnet protocols. Some distributed devices implement a local software that emulates telnet communications. Emulation of the telnet communications improves a user interface and enables complex local functionality while leveraging an existing telnet infrastructure.

Processing capabilities in the distributed devices are increasing. For instance, modern rugged devices include powerful processors and chipsets, which enable operation of local large language models (local LLMs). Use of the local LLMs significantly increases the processing capabilities available at the rugged devices.

Many distributed devices operate in specific environments such as inventory management in a warehouse, procedure documentation in a healthcare facility, or point of sale (POS) operations of a particular vendor facility. Accordingly, in these and other environments the local LLMs may output inaccurate or irrelevant results. For instance, a rugged device may receive an image of items in a vendor environment (e.g., an image of five boxes of crackers on a shelf). The local LLMs on the distributed device may process the image by against hundreds or thousands of similar, yet irrelevant images, which might result in inaccurate identification of the subjects of the image.

The local LLMs may be trained to improve accuracy of output. However, generation of training data requires significant computing resources and technological proficiency. Oftentimes, the distributed devices are operated by individuals without the level of sophistication to the generate training data. Moreover, the distributed devices lack local computing resources build discrete training data sets and to adapt the training data sets as an environment changes. Accordingly, there is a need in the field of local LLM-enabled rugged devices to facilitate generation and adaptation of profiles.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a system for profile-based large language model (LLM) processing in inventory management environments. The system may include a host system, a cloud device, a rugged device, and an admin device. The host system may include an inventory management system. The rugged device may include an imaging device, a local LLM engine, and an emulation module. The rugged device may be in network communication with the cloud device and the host system. The admin device may include a profile creation module. The admin device is configured to receive a profile creation user interface. The profile creation user interface overlays a profile generation module. The admin device is configured to receive training information at the profile creation user interface. Responsive to the training information, the admin device is configured to collate the training information into an adaptive profile. The adaptive profile may include a data set configured to direct output and decisions of an artificial intelligence (AI)-based LLM and may be generated for a rugged device having local LLM functionality. The admin device is configured to communicate the adaptive profile to the cloud device such that the adaptive profile is remotely stored at the cloud device and accessible to the rugged device. The rugged device is configured to access the adaptive profile from the cloud device and implement the adaptive profile such that the adaptive profile is used to modify the local LLM engine during inventory management operations. The rugged device is configured to receive image data captured at the imaging device. The image data may include an image of one or more objects in an inventory management environment. The rugged device processes the captured data using the local LLM engine based on the adaptive profile. The processing may include a determination of a metric related to the objects. The emulation module is configured to generate an inventory data message based on the processed captured data, to translate the inventory data message to a protocol of a host system, and to communicate the translated message to the host system. The host system is configured to communicate inventory screen data in the host protocol to the rugged device and to receive inventory messages in the host protocol from the rugged device.

According to another aspect of the invention, an embodiment includes a method for profile-based LLM processing in inventory management environments. The method may include receiving, at a first device, a profile creation user interface. The profile creation user interface overlays a profile generation module. The method may include receiving, at the first device, training information at the profile creation user interface. Responsive to the training information, the method may include collating the training information into an adaptive profile. The adaptive profile may include a data set configured to direct output and decisions of an AI-based LLM. The adaptive profile may be generated for a second device having local LLM functionality. The method may include communicating the adaptive profile to a cloud device such that the adaptive profile is remotely stored and accessible at the cloud device. The method may include accessing, by the second device, the adaptive profile from the cloud device and implementing the adaptive profile such that the adaptive profile is used to modify the local LLM engine during inventory management operations. The method may include receiving image data captured at an imaging device. The image data may include an image of one or more objects in an inventory management environment. The method may include processing the captured data using a local LLM engine based on the adaptive profile. The processing may include a determination of a metric related to the objects. The method may include generating an inventory data message based on the processed captured data. The method may include translating the inventory data message to a protocol of a host system. The method may include communicating the translated message to a host system such that data represented in the translated message are integrated into an inventory management database at the host system.

According to yet another embodiment of the invention, an embodiment includes a method of adaptive profile generation in an inventory management system. The method may include receiving a profile creation user interface. The profile creation user interface overlays a profile generation module. The method may include receiving training information at the profile creation user interface. Responsive to the training information, the method may include collating the training information into an adaptive profile. The adaptive profile may include a data set configured to direct output and decisions of an AI-based LLM and may be generated for a rugged device having local LLM functionality. The method may include communicating the adaptive profile to a cloud device such that the adaptive profile is remotely stored at the cloud device and accessible to a rugged device.

An additional aspect of an embodiment includes a non-transitory computer-readable medium having encoded therein programming code executable by one or more processors to perform or control performance at least a portion of the methods described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments of the present disclosure are implemented;

FIGS. 2A-2D depict an example adaptive profile generation and operation process (process) that may be implemented in the operating environment of FIG. 1;

FIG. 3 is a sequence diagram of the process of FIG. 2;

FIG. 4 illustrates an example computer system configured for profile-based AI processing in inventory management environments;

FIGS. 5A and 5B are a flowchart of an example method for profile-based AI processing in inventory management environments,

FIG. 6 is a flowchart of an example method of adaptive profile augmentation to a LLM in an inventory management system; and

FIG. 7 is a flowchart of an example method of adaptive profile generation in an inventory management system, all according to at least one embodiment described in the present disclosure.

### DESCRIPTION OF SOME EXAMPLE EMBODIMENTS

The embodiments described in this disclosure are related to management of distributed devices in supply chain environments. In particular, the embodiments relate to augmenting artificial intelligence (AI) engines that are implemented to direct local AI engines at distributed devices using adaptive profiles.

For instance, modern distributed devices are outfitted with improved processors that are capable of running local AI engines such as large language models (LLMs). The AI engines can be used to analyze and process data such as image data input to the distributed devices. This capability may be leveraged in terminal emulation to improve inventory management operations. However, the AI engines, especially LLMs, often result in inaccurate or irrelevant output that is unusable in the inventory management operations. For instance, the local LLMs may process image data using thousands of unrelated and irrelevant images. Accordingly, there is a need to implement adaptive profiles as described in the present disclosure that augment the analysis performed by the LLMs to direct the output to relevant and accurate output.

Operators of the distributed devices might not have sufficient technical sophistication to generate profiles that are effective to direct the local LLM in a specific environment. Additionally, the distributed devices may not have sufficient computing resources to generate and implement the adaptive profiles.

Additionally, environments in which the distributed devices are implemented regularly change (e.g., new items are added, inventory is organized differently, packaging changes, etc.). The changes to the environments oftentimes result in a need to update the adaptive profiles. Failure to update the adaptive profiles might result in poorly utilized local LLMs and inaccurate output from the local LLMs.

Accordingly, some embodiments of the present disclosure are directed to remote generation of adaptive profiles that are locally implemented at distributed devices. The adaptive profiles are based on the training information relevant to an operating environment of the distributed devices. The adaptive profiles are remotely generated by computing devices with sufficient computing resources to process the training information. The adaptive profiles may be accessed by the distributed devices and locally implemented to direct output of the local LLMs. Additionally, in some embodiments the adaptive profiles may be regularly updated based on the image data captured and processed during use. The updates to the adaptive profile address changes to the environment and overcome shortcomings of implementing static profiles.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of some example configurations of the systems and methods.

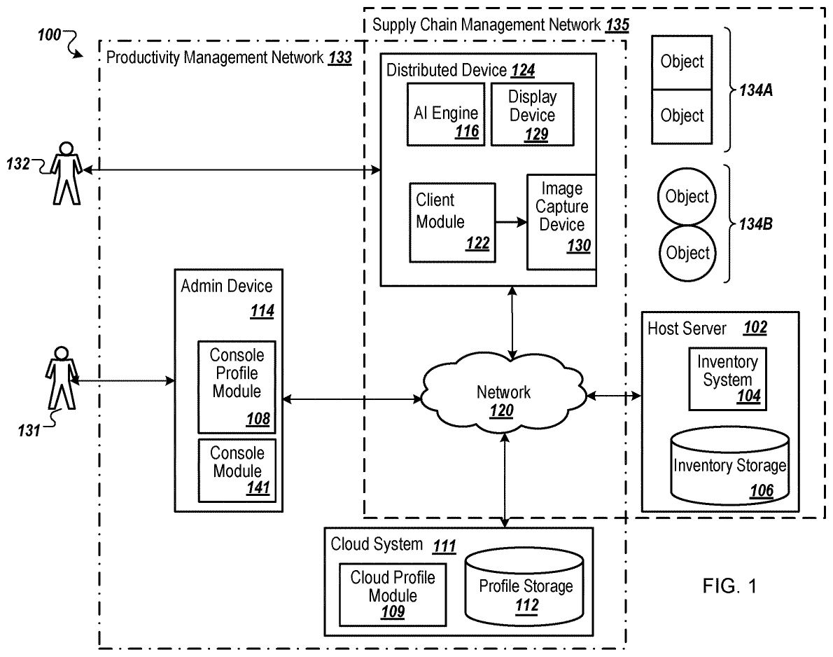

FIG. 1 is a block diagram of an example operating environment 100 in which some embodiments of the present disclosure may be implemented. In the operating environment 100, an adaptive profile is remotely generated by an admin device 114 and/or a cloud system 111 and accessed by a distributed device 124. The adaptive profile is used to augment a local artificial intelligence (AI) engine 116 at the distributed device 124 during inventory management operations. Specifically, adaptive profile is implemented to direct output of the AI engine 116 in the context of inventory management operations.

The adaptive profiles are data sets generated based on training information related to objects 134A and 134B (collectively, object 134 or objects 134). The training information is input by an administrator (hereinafter, “admin”) 131 and/or a user 132. After the adaptive profile is generated and used, the adaptive profile may be updated. For instance, the adaptive profile may be used during inventory management operations to process image data captured by the distributed device 124. The image data may then be fed back into a profile module 108 or 109 to refine or modify the adaptive profile. An updated profile may be generated, which is then used in subsequent inventory management operations.

The adaptive profile and updated profile improve operation of the distributed device 124 and improve inventory management operations in the operating environment 100. For instance, the distributed device 124 such as rugged devices or barcode scanner devices have upgraded chipsets that enable operation of the AI engine 116. However, without the adaptive profile, the AI engine 116 are poorly suited to analyze image data in the context of inventory management. For instance, the AI engine 116 by itself does not produce the metrics related to inventory operations and does not integrate its output into an inventory management system such as inventory system 104. The adaptive profile directs the AI engine 116 to analyze the image data and output a metric requested in the inventory management operation. Specifically, the adaptive profile is based on digital images of the objects 134 as they exist or similar to how they exist in the operating environment 100. Additionally, a console profile module 108 might include forms that include fields in which additional information related to the digital images may be input. The additional information and the digital images are input as training information to the console profile module 108. The console profile module 108 generates a dataset based on the training information, which is the adaptive profile. The adaptive profile is then accessed by the distributed device 124 and used during inventory management operations. The adaptive profiles are then input to the AI engine 116 to direct the AI engine 116 to output metrics relevant to the inventory management operations and relayed to the inventory system 104.

Additionally, in some embodiments, the adaptive profiles include a derivative function. The derivative function further processes the metrics output by the AI engine 116 in the context of the inventory management system. The derivative function further improves inventory management operations by integrating additional tasks and processes as inventory management operations are performed.

The operating environment 100 includes the admin device 114, the distributed device 124, the host server 102, and the cloud system 111 (collectively, “environment components”). The environment components communicate via a communication network 120 (in FIG. 1, “network”) for generation and use of the adaptive profile. In FIG. 1, the environment components are implemented in a productivity management network 133 and a supply chain management network 135. The communication network 120, the environment components, the productivity management network 133, and the supply chain management network 135 are introduced in the following paragraphs.

The communication network 120 may include one or more wide area networks (WANs) and/or local area networks (LANs) that enable the environment components to communicate with one another. In some embodiments, the communication network 120 may include the Internet in which communicative connectivity between the components of the operating environment 100 is formed by logical and physical connections between multiple WANs and/or LANs. Additionally or alternatively, the communication network 120 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The communication network 120 may also include servers that enable one type of network to interface with another type of network.

The productivity management network 133 is generally indicated by a dash-dot border (e.g., ‘-⋅-‘ in FIG. 1) and the supply chain management network 135 is generally indicated by a dashed border (e.g., ‘- - - ’ in FIG. 1). The distributed device 124 is included in both the productivity management network 133 and the supply chain management network 135. The distributed device 124 is operated a user 132 to perform inventory management operations such as movement and organization of the objects 134 in a supply chain. The productivity management network 133 is implemented with the supply chain management network 135 to improve usability and efficiency of the inventory management operations.

For instance, the supply chain management network 135 may be implemented to track the objects 134 as they move through a supply chain such as from a manufacturing facility to a warehouse, then to a delivery truck, and then to a store or within a store from a warehouse to a shelf and then to a consumer. The supply chain management network 135 is deployed to track the objects 134 as the objects 134 move through a series or set of inventory management operations.

In the supply chain management network 135, the host server 102 and/or software implemented thereon centrally tracks inventory data input from distributed device 124. For instance, in the embodiment of FIG. 1, the host server 102 implements the inventory system 104 and the inventory storage 106. The inventory system 104 may generate requests or tasks communicated to the distributed device 124. The request may take the form of screen data that are communicated to the distributed device 124 and displayed on a display device 129. The screen data may define fields configured to receive input from the user 132 during inventory management operations. Responses are communicated from the distributed device 124 to the inventory system 104 and stored in the inventory storage 106. For instance, the user 132 might provide input at the distributed device 124, which is then communicated (or reformatted and communicated as described below) to the inventory system 104 and stored at the inventory storage 106.

The supply chain management network 135 may implement a simple protocol such as telnet protocol (e.g., Telnet) or another similar data communication protocol (collectively, telnet protocols) as a basis of data communication between the distributed device 124 and the host server 102. For instance, the screen data may be formatted according to one of the telnet protocols. Similarly, responses that provide metrics related to inventory management operations may be formatted according to one of the telnet protocols. The telnet protocols may have limited functionality such as uncommon or user-hostile user interface functionality, restricted data entry functionality, and rigid display features.

The host server 102 includes a hardware-based computing device. The host server 102 may be a centralized repository and management program that communicates data with the distributed device 124. In some embodiments, the data is communicated via one of the telnet protocols. The data includes a user interface into which information is entered. The distributed device 124 may include a scanner device, which enters information into the user interface by scanning a barcode. The information from the scanner device is communicated to the host server 102. The data may be communicated via the communication network 120. Additionally, in some embodiments the distributed device 124 may communicate a portion of the data via a dedicated wired communication network.

The distributed device 124 may include hardware-based computing systems that are configured to communicate with other environment components via the communication network 120. The distributed device 124 may include a computing device configured to perform operations in the supply chain management network 135. For instance, the distributed device 124 may include a scanner device, a rugged device, or a mobile or smart device, which may include an image capture device 130 such as a scanner or camera. The distributed device 124 may include, have integrated, or be coupled to the image capture device 130. In some embodiments, the distributed device 124 may be a rugged device used in an industrial setting, such as a warehouse environment. In other embodiments, the distributed device 124 may include a rugged device implemented in a store or market. In yet other embodiments, the distributed device 124 may include a point-of-sale (POS) device such as a check-out machine in a marketplace.

The distributed device 124 includes a client module 122, which is part of the productivity management network 133. The client module 122 is configured to implement operations defined by a console module 141 of the admin device 114. The distributed device 124 further includes the display device 129 on which user interfaces and digital images may be displayed. The distributed device 124 includes the AI engine 116, which may include a local large language model (LLM). Some examples of the AI engine 116 include a lightweight LLM such as Gemma-2B™, Phi-2™, StableLM-3B™, or another suitable LLM.

In the embodiment of FIG. 1, the user 132 performs inventory management operations using the distributed device 124. At least a portion of information and input entered into the distributed device 124 may be image data. In some embodiments, the image data is captured using the image capture device 130. For instance, the user 132 might use the image capture device 130 to take a photo of the objects 134. The image data is then processed by the AI engine 116 augmented by the adaptive profile and the client module 122 as described elsewhere in the present disclosure. Alternatively, the image data may be received from another distributed device or another image capture device 130.

The image data generally include an image or photograph of the objects 134 or some portion thereof. In general, the image data is configured to provide some representation of the objects 134 in an environment such as a warehouse or marketplace. For instance, the image data might be a photograph or image or boxes of soccer balls on a shelf or bottles in a display cabinet. In some embodiments, the image data is displayed on the display device 129 at least temporarily prior to being processed by the AI engine 116 and adaptive profile, which may enable the user 132 to view the image data before processing.

To improve usability and functionality of the distributed device 124, the productivity management network 133 may be implemented. The productivity management network 133 may be deployed at least partially “on top of” the supply chain management network 135. For instance, the productivity management network 133 may improve the user interface, optimize data entry, improve display features and functions, and provide and update the adaptive profile. Additionally, the productivity management network 133 may harvest and process data entered during performance of the operations to provide metrics, recommendations, and oversight regarding operational efficiency.

The productive management network 133 includes the emulation module 212 of the distributed device 124, the admin device 114, and the cloud system 111. The client module 122 may receive data (e.g., screen data) from the inventory system 104 and re-format or transform it and then cause display of a transformed version of the screen data on the display device 129. For instance, the screen data received from the inventory system 104 may be formatted according to the Telnet protocol. On the fly, the client module 122 may receive and reformat the screen data into hypertext markup language (HTML). The client module 122 may cause display of the HTML version of the screen data. Accordingly, a user interface on the display device 129 may be an HTML user interface representative of the screen data.

The user 132 may input information directly into the user interface using the distributed device 124. The input may include text or audio input. Additionally, the image data may be input into the distributed device 124. The AI engine 116 may process the image data using the adaptive profile. The client module 122 may reformat the information to the telnet protocol before it is sent to the inventory system 104.

The admin device 114 may include a hardware-based computing system that is configured to communicate with other environment components via the communication network 120. The admin device 114 may include a console computing device such as a laptop, desktop computer, etc. The admin device 114 includes a console module 141 that configures the client module 122 and configuration of operations performed by the client module 122 implemented at the distributed device 124. For instance, the console module 141 develops the screen transformations, series of screens, and enables customization of the screen data and information processing. For instance, the console module 141 may enable customization of buttons and fields displayed at the distributed device 124. Additionally, the console module 141 may enable definition of prompts or other profile configuration data. The console module 141 may be operated by the admin 131. After the client module 122 is configured, it may be pushed to the distributed device 124 or communicated to the cloud system 111 such that it may be accessed by the distributed device 124. The admin device 114 may also include the console profile module 108, which is described elsewhere in the present disclosure.

The admin device 114 includes a console profile module 108. The console profile module 108 is configured to receive a profile creation user interface from the cloud system 111. The profile creation user interface overlays the console profile module 108. The console profile module 108 receives training information at the profile creation user interface. For instance, the admin 131 may take a digital photograph of the objects 134. The admin 131 then uploads or otherwise inputs the digital photograph into the profile creation user interface such that the console profile module 108 receives it. In addition, the admin 131 may input data via one or more forms. Using the forms, the admin 131 may provide identifying information relative to the digital photograph. The digital photograph and the information in the forms are used as training information. Responsive to the training information, the console profile module 108 collates the training information into an adaptive profile. The adaptive profile includes a data set configured to direct output and decisions of the AI engine 116. The console profile module 108 communicates the adaptive profile to the cloud system 111 such that the adaptive profile is remotely stored at the cloud system 111 in the profile storage 112 and accessible to the distributed device 124.

The admin device 114 includes additional computing resources compared to the distributed device 124. The additional computing resources enable functionality of the console profile module 108. For instance, the admin device 114 may include a workstation such as a desktop or laptop computer. The computing power of the admin device 114 may be greater than the computing power of the distributed device 124. Additionally, the admin device 114 may be operated by the admin 131. The admin 131 may have more technical sophistication than the user 132. Accordingly, the adaptive profile may be generated by a more sophisticated operator using a more powerful computing system, which enables the adaptive profile to be well suited for operation in the operating environment 100 when compared to profiles generated at the distributed device 124 by the user 132.

The cloud system 111 may include hardware-based computing system that is configured to communicate with other environment components via the communication network 120. The cloud system 111 hosts some components of the productivity management network 133. For instance, the cloud system 111 may host the generated adaptive profile such that the adaptive profile can be accessed by the distributed device 124. Similarly, the cloud system 111 may host the console module 141 and the profile creation user interface such that it may be accessed by the admin device 114.

The cloud system 111 enables access to the adaptive profile by the distributed device 124 or other distributed devices, which may be implemented in the operating environment 100. For instance, the user 132 may log into the distributed device 124. After the user 132 logs in, the user 132 may interface with the cloud system 111 to access the adaptive profile from the profile storage 112. In these embodiments, the distributed device 124 is configured to access the adaptive profile from the cloud system 111 and implement the adaptive profile such that the adaptive profile is used to modify the AI engine 116 during inventory management operations.

After the adaptive profile is accessed, the distributed device 124 may receive image data captured at the image capture device 130. The image data includes an image or digital representation of the objects 134 in an inventory management environment. The AI engine 116 processes the captured data based on the adaptive profile to determine a metric related to the objects 134 such as the identity of the objects 134, a number of the objects 134, etc.

The emulation module 212 is configured to generate an inventory data message based on the processed captured data and the determined metric. For instance, the determined metric may be the identity, quantity, and location of the objects 134. Accordingly, the inventory data message may include data representative the identity, location, and quantity of the objects 134. The emulation module 212 translates the inventory data message to a protocol of the host server 102 and communicates the translated message to the host server 102.

The cloud system 111 also includes the cloud profile module 109. In some embodiments, in addition to processing the image data at the distributed device 124 (e.g., using the adaptive profile and the AI engine 116), the image data may be communicated to the cloud profile module 109. The cloud profile module 109 uses the image data and/or metric data related to the image data as additional training information. Based on the additional training information, the cloud profile module 109 may generate an updated profile. The updated profile is a modified version of the adaptive profile with the additional training information. The updated profile is then stored at the profile storage 112 where it is accessible to the distributed devices 124.

In some embodiments, the cloud system 111 may be a single server, a set of servers, a virtual device, or a virtual server in a cloud-based network of servers. In these and other embodiments, instead of the console profile module 108 of the admin device 114 collating the training information, the admin device 114 may access the cloud profile module 109 via an appserver. For instance, the admin device 114 may include a browser application that accesses the appserver at the cloud system 111. The training information (e.g., the photograph and form information) may be entered into the cloud profile module 109. The cloud profile module 109 may generate the adaptive profile and store it at the profile storage 112.

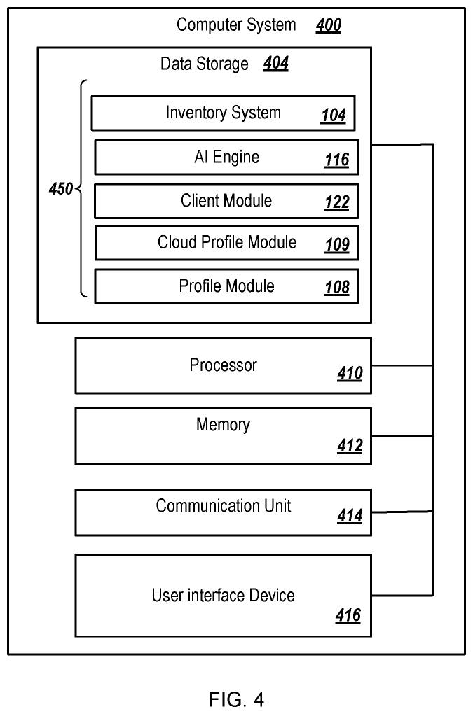

The console module 141, the AI engine 116, the console profile module 108, the cloud profile module 109, and the client module 122, (collectively modules) and components thereof may be implemented using hardware including a processor, a microprocessor (e.g., to perform or control performance of one or more operations), a field-programmable gate array (FPGA), or an application-specific integrated circuit (ASIC). In some other instances, the modules or components thereof may be implemented using a combination of hardware and software. Implementation in software may include rapid activation and deactivation of one or more transistors or transistor elements such as may be included in hardware of a computing system (e.g., the distributed device 124, the admin device 114, or the cloud system 111 of FIG. 1). Additionally, software defined instructions may operate on information within transistor elements. Implementation of software instructions may at least temporarily reconfigure electronic pathways and transform computing hardware. The inventory storage 106 and the profile storage 112 may be examples of or include the memory 412 or the data storage 402 described with reference to FIG. 4.

Modifications, additions, or omissions may be made to the operating environment 100 without departing from the scope of the present disclosure. For example, the operating environment 100 may include one or more distributed device 124, one or more admin devices 114, one or more host servers 102, one or more cloud systems 111, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

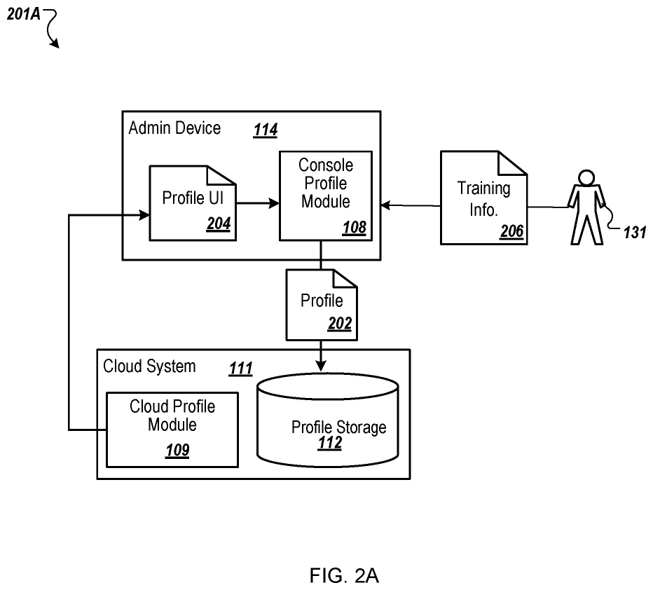

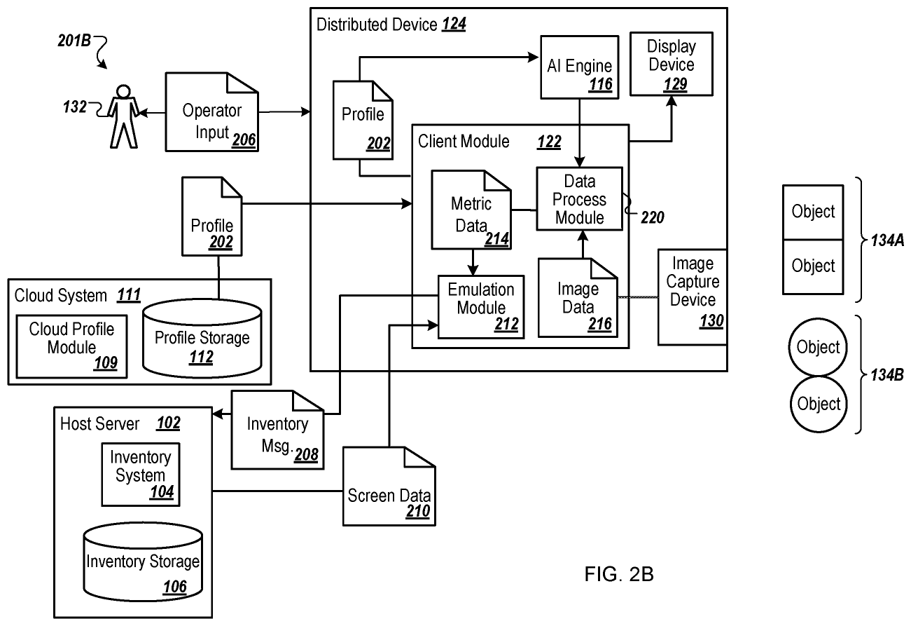

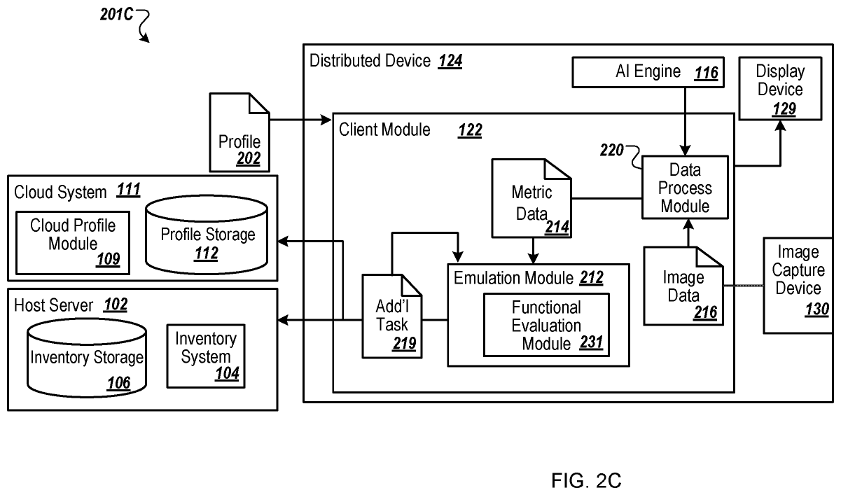

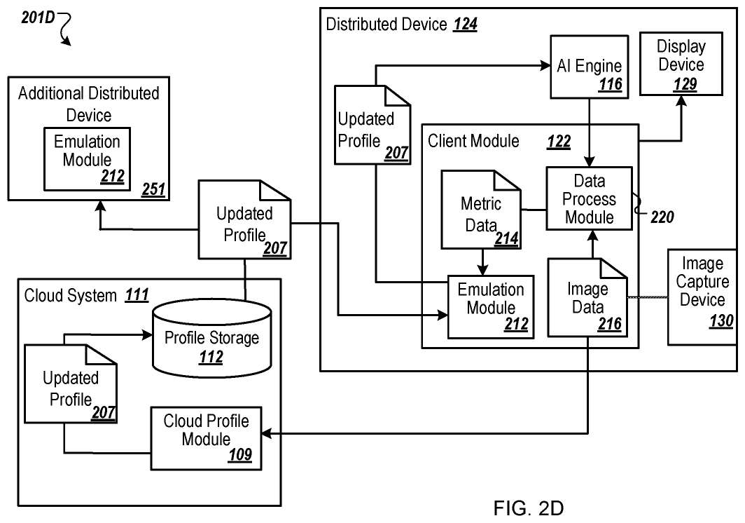

FIGS. 2A-2D depict an example adaptive profile generation and operation process (process) 200 that may be implemented in the operating environment 100 of FIG. 1 or another suitable operating environment. FIGS. 2A-2D include multiple components (e.g., 124, 111, 102, 134, etc.) described with reference to FIG. 1. Although not depicted in FIGS. 2A-2D, communication of information and data may be via a network such as the communication network 120 of FIG. 1.

FIG. 2A depicts a first portion 201A of the process 200 in which an adaptive profile 202 (hereinafter, profile 202) is generated and stored. FIG. 2B depicts a second portion 201B in which the profile 202 is implemented at the distributed device 124. FIG. 2C depicts a third portion 201C of the process 200 in which a derivative function is applied. FIG. 2D depicts a fourth portion 201D of the process 200 in which an updated profile 207 is generated and distributed. Each of the four portions 201A-201D are described below.

Referring to FIG. 2A, a first portion 201A of the process 200 may begin with communication of a profile creation user interface (UI) 204 (in FIG. 2A “profile UI”) by the cloud system 111 to the admin device 114. The profile creation UI 204 overlays the console profile module 108 that is configured to generate the profile 202. The profile creation UI 204 includes a UI configured to receive training information 206 from the admin 131.

For instance, the profile creation UI 204 includes a portion that receives image data such as photographs or digital files. Additionally, the profile creation UI 204 may include one or more forms or a form UI. The forms are configured to receive administrative input such as text or audio input that enables description of items in the image data. In some embodiments, the descriptions may include selection of items from lists, free-form text, copy of related descriptions, etc. The information input into the forms may be used to describe the image data. For instance, the information may include a description of an object name, description of a use case or use environment, identity of objects in the image data, other information relevant to the image data, or some combination thereof. The image data and optional information input using the forms comprise the training information 206. For instance, the training information 206 may include a digital photograph of a soccer ball in a box. In a form, the admin 131 may input a description such as “company X soccer ball, model ‘World Cup series,’ size 5.” Accordingly, the training information 206 in this example may include the photograph along with the description.

The console profile module 108 collates the training information 206 to generate the profile 202. The profile 202 is configured to direct output of a local LLM (e.g., the AI engine 116 of FIG. 1) of the distributed device 124. In these and other embodiments, the local LLM refines its out-of-the-box rules and parameters based on the profile 202. The profile 202 is a dataset that represents the training information 206 in organized and structured format. For example, collation of the training information 206 may include annotating image data or portions of the image data with descriptions, defining relationships and patterns within image data, and the like. Additionally, the profile 202 or portions thereof may be labelled to indicate an environment in which the profile 202 is applicable. In some embodiments, the profile 202 may provide specifically identified data and/or prompts that adjust parameters of the local LLM to match or track the training information 206.

The console profile module 108 communicates the profile 202 to the profile storage 112 at the cloud system 111. In some embodiments, the profile 202 may be received by the cloud profile module 109. The cloud system 111 may provide remote storage for two or more admin devices 114. In these embodiments, the cloud system 111 may identify the admin device 114 and store the profile 202, such that it is available only to distributed devices (e.g., 124) associated with the admin device 114. Additionally, in some embodiments, the cloud profile module 109 may further refine the profile 202. For instance, the cloud profile module 109 may have access to other, previously developed profiles, which may be combined with the profile 202. The profile 202 is stored at the profile storage 112 such that it is accessible to distributed devices, which is described with reference to FIG. 2B.

In some embodiments, the cloud profile module 109 may perform some or all of the operations attributed to the console profile module 108. In these embodiments, the console profile module 108 at the admin device 114 may use the profile creation UI 204 to collect the training information 206, which is communicated to the cloud profile module 109. The cloud profile module 109 may generate the profile 202 using collation operations. The cloud profile module 109 may be stored at the profile storage 112 as described above.

In some embodiments, the console profile module 108 may be omitted from the admin device 114. In these embodiments, the cloud profile module 109 may be hosted on the cloud system 111 and accessed via an appserver. In these embodiments, the profile generation module is accessed by the admin device 114 using a browser application running on the admin device 114. The appserver may host the profile creation UI, which enables input of the training information 206, which is relayed to the cloud profile module 109 to enable generation of the profile 202.

FIG. 2B depicts the second portion 201B of the process 200 in which the profile 202 is accessed and implemented during inventory management operations. The second portion 201B may occur following the first portion 201A or may occur following the fourth portion 201D with an updated profile 207 of FIG. 2D. The second portion 201B may begin with the distributed device 124 accessing the profile 202 from the profile storage 112. For instance, in some embodiments, the user 132 may be tasked with performance of one or more inventory management operations using the distributed device 124. The user 132 may log into the distributed device 124. After the user 132 logs into the distributed device 124, the client module 122 may open a communication channel with the cloud system 111. The client module 122 may then request, download, or be pushed the profile 202 via the communication channel. In some implementations, the distributed device 124 might perform some synchronization or authorization operations to determine whether the profile 202 exists in the profile storage 112 and to ensure the distribution device 124 has permission to access the profile 202.

After the profile 202 is accessed from the profile storage 112, it is stored at the distributed device 124. The profile 202 is locally stored at the distributed device 124 to enable use of the profile 202 by the AI engine 116 without consistent communication with the cloud system 111. For instance, the communication channel via which the profile 202 is accessed does not need to be maintained as the profile 202 is used.

The inventory management operations may be determined at least partially by the host server 102. For instance, the inventory system 104 and the inventory storage 106 may operate as a central repository of inventory of an environment in which the distributed device 124 operates. The inventory system 104 communicates screen data 210 to the distributed device 124. The screen data 210 includes fields configured to receive information gathered by the distributed device 124. The emulation module 212 intercepts and reformats the screen data 210 before it is displayed at the display device 129.

The screen data 210 may be reformatted by the emulation module 212 before it is displayed on the display device 129. The screen data 210 or a reformatted version thereof is then displayed on the display device 129. The screen data 210 requests some information related to an inventory management operation. For instance, a particular field may request the number of the objects 134 a location of the objects 134, etc.

The requested information may be input to the distributed device 124 as image data 216. For instance, in the embodiment of FIG. 2B, the distributed device 124 includes the image capture device 130 that may be used in the inventory management operations. For instance, the user 132 may be tasked with determining numbers of the objects 134 in an environment, may be tasked with a picking (e.g., gathering a number of the objects 134 to fulfill an order), a relocation operations, etc. To complete these and other tasks, the user 132 may use the image capture device 130 to photograph the objects 134. For example, the user 132 may photograph a shelf or a pallet on which the objects 134 are placed. The image capture device 130 generates image data 216, which is a digital image or data representative thereof. In some embodiments, the requested information may also be input to the distributed device 124 verbally (via a microphone) and/or via a user interface (e.g., a touch screen or keyboard).

The image data 216 is received by a data process module 220. The data process module 220 interfaces with or utilizes the AI engine 116 and the profile 202 to process the image data 216. For instance, the AI engine 116 may analyze the image data 216 to count or identify the objects 134 included therein. The profile 202 is input to the AI engine 116 to direct output of the AI engine 116. The profile 202 is a data set based on the training information, which adjusts the AI engine 116 such that the output is accurate and relevant to the inventory management operation.

The data process module 220 is configured to determine a metric relative to the objects of the image data 216. For instance, the screen data 210 (or reformatted version thereof) may request a number of the objects. Accordingly, the data process module 220 may utilize the AI engine 116 and the profile 202 to determine the number of the objects in the image data 216.

The data process module 220 outputs metric data 214, that represents the metric of the image data 216 determined by the AI engine 116. The metric data 214 is received by the emulation module 212 as an entry of the requested information in the screen data 210. The user 132 may confirm or reject the metric data 214 and may provide additional information as text and/or as verbal input.

Based on the metric data 214 and optional additional information, the emulation module 212 may generate an inventory data message that is responsive to the displayed screen data 210. The emulation module 212 may transform the inventory data message to the protocol of the host server 102 and communicate a translated inventory data message 208 to the host server 102. The translated inventory data message 208 may be received by the inventory system 104 and stored in the inventory storage 106.

FIG. 2C depicts a third portion 201C of the process 200 in which a derivative function is applied. As introduced with reference to FIG. 1, the profile 202 may include a derivative function. The derivative function includes an additional instruction that receives as input the metric data 214 and triggers an additional task based on the metric data 214.

In some embodiments, the emulation module 212 may include a functional evaluation module 231. The functional evaluation module 231 may be configured to receive the metric data 214 and implement the derivative function based on the received metric data 214. Additionally, the functional evaluation module 231 may generate and communicate an additional task instruction 219 (in FIG. 2C, “Add'l task”). For instance, responsive to the derivative function resulting in an additional task, the functional evaluation module 231 generates an instruction scheduling the additional task.

An example of the derivative function is a restock function. The restock function is based on a threshold value, which is compared to the metric data 214. Responsive to the metric data 214 being below the threshold value, the emulation module 212 triggers a restock operation. Other derivative functions may include re-location operations (moving objects 134 in the environment), sale operations (e.g., price reduction recommendations), environment-wide assessment operations (e.g., contributing the metric data 214 to an aggregation function), and the like.

The output of the derivative function may include scheduling or triggering another task instruction 219. For instance, the restock function might result in scheduling the restock task to be executed by the operator using the distributed device 124. Additionally or alternatively, the task may be communicated to the host server 102 or the cloud system 111 to be executed by another operator or an additional rugged device (e.g., 251 of FIG. 2D).

Responsive to the metric data 214 triggering the additional task, the functional evaluation module 231 may communicate the additional task instruction 219 to the host server 102. For example, referring to the above example, the additional task instruction 219 may include a message scheduling a restock task relative to the objects 134. Alternatively, the additional task instruction 219 may be communicated to the cloud system 111 (such that it is assigned to the additional rugged device 350) or processed at the distributed device 124.

FIG. 2D depicts a fourth portion 201D of the process 200 in which an updated profile 207 is generated and distributed. In FIG. 2D, an additional distributed device 251 is included with the distributed device 124 and the cloud system 111. The additional distributed device 251 is substantially similar to the distributed device 124. The updated profile 207 is generated based on the image data 216. For example, the image data 216 is used as additional training information that is used the modify the profile 202 of FIGS. 2A-2C. For instance, similar to the description of the generation of the profile 202 in FIG. 2A, the image data 216 may be ingested by the cloud profile module 109. The cloud profile module 109 may use the image data 216 as additional training information. Based on the additional training information, the cloud system 111 generates the updated profile 207. For instance, the additional training information is used to modify and improve the profile 202. The additional training information modifies the data set of the profile 202 to refine operation and analysis of the AI engine 116. In some embodiments, in addition to the image data 216, the additional training information may include the metric data 214 or other contextual information related to the inventory data message 208.

After the updated profile 207 is generated, the cloud system 111 stores the updated profile in the profile storage 112. The profile storage 112 is accessible to one or more rugged devices 124 or 251. For instance, after the update profile 207 is generated and stored at the cloud system 111, the additional distributed device 251 or the distributed device 124 may access the updated profile 207. The update profile 207 may be implemented locally at the additional distributed device 251 or the distributed device 124 to process additional image data captured or otherwise produced during inventory management operations as described with reference to FIG. 2B. The fourth portion 201D of the process 200 may be repeated. For instance, as the image data 216 (or additional image data) is collected, the image data 216 may be provided as additional training information to generate additional updated profiles 207. Accordingly, the update profiles 207 continue to improve, which improves processing of the AI engine 116.

The generation of the updated profile 207 is implemented by the cloud profile module 109 at the cloud system 111. The cloud system 111 includes greater computing power relative to the distributed device 124 and the additional distributed device 251. Accordingly, the cloud profile module 109 may ingest and process more information than the distributed devices 124 and 251.

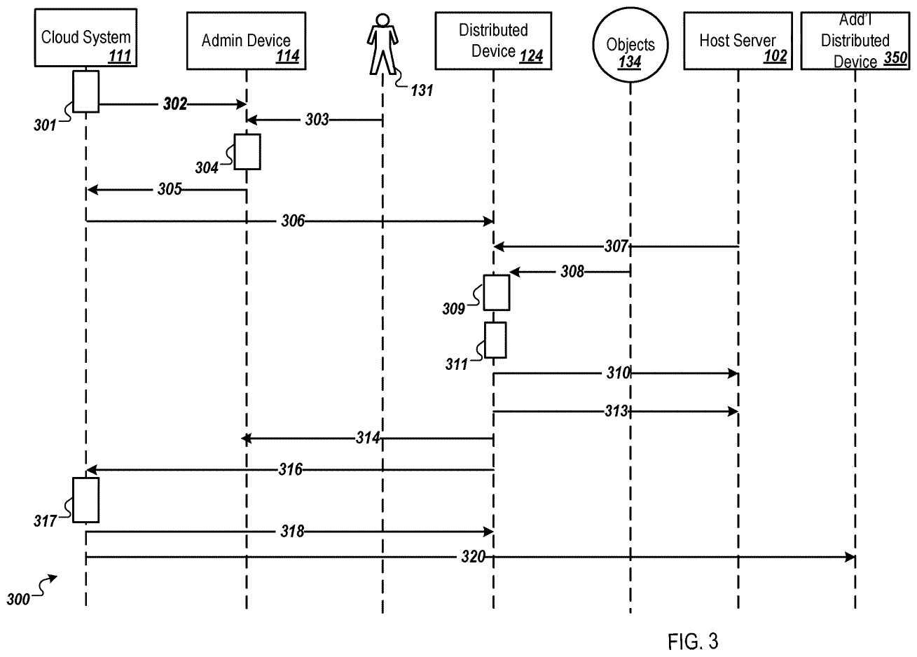

FIG. 3 is a sequence diagram of an example adaptive profile generation and implementation process (process) 300 that may be implemented in the operating environment 100 of FIG. 1 or another suitable operating environment. The process 300 includes the cloud system 111, the admin device 114, the admin 131, the distributed device 124, the object 134, and the host server 102 described elsewhere in the present disclosure. The process 300 also includes an additional rugged device 350 that is substantially similar to the distributed device 124. The process 300 may begin with generation and communication (301 and 302) of a profile creation UI by the cloud system 111. The cloud system 111 communicates the profile creation UI to the admin device 114. The profile creation UI overlays a profile generation module. The profile creation UI may include one or more forms or form interface portions that are configured to receive administrative input such as text or item selection. The administrative input may be used to describe the training information, description of an object name, description of a use case or use environment, other administrative input, or some combination thereof. In some embodiments, the profile generation module may be hosted on the cloud system 111 and accessed via an appserver. In these embodiments, the profile generation module is accessed by the admin device 114 using a browser application running on the admin device 114.

The admin 131 may input (303) training information into the profile creation UI. The training information includes a digital image or one or more objects. For instance, the training information may include a photograph or digital photograph of a soccer ball in a box. In a form the admin 131 may input a description such as company X soccer ball, model “World Cup series,” and size 5. Accordingly, the training information in this example may include the photograph along with the description.

The admin device 114 collates (304) the training information to generate an adaptive profile. The adaptive profile includes a data set that directs output of a local LLM of the distributed device 124. For instance, the adaptive profile provides a specifically identified data and prompts the local LLM to adjust parameters to match the training information. Additionally, the local LLM refines its out-of-the-box rules based on the training information. Alternatively, in some embodiments, the admin device 114 may access the appserver at the cloud system 111. In these embodiments, the training information is input to the appserver via the browser application at the admin device 114 and the cloud system 111 collates (304) the training information to generate the adaptive profile.

The admin device 114 communicates (305) the adaptive profile to the cloud system 111. The adaptive profile is stored at the cloud system 111 such that it is accessible to the distributed device 124 and the additional rugged device 350.

The distributed device 124 access (306) the adaptive profile from the cloud system 111. For instance, the distributed device 124 and the additional rugged device 350 (collectively, devices 124 and 350) may be operated by warehouse workers. To operate the devices 124 and 350, the warehouse workers might log into the devices 124 and 350 (e.g., at the beginning of their shift). After the login operation, the devices 124 and 350 may access the cloud system 111, determine whether the adaptive profile exists on the cloud system 111. Responsive to the adaptive profile being stored at the cloud system 111, the devices 124 may download the adaptive profile such that it is stored on the devices 124 and 350 and implemented to augment function of a local LLM to support an emulation module.

The host server 102 communicates (307) display instructions to the distributed device 124. The host server 102 operates an inventory system that communicates display instructions for presentation on the devices 124 and 350. The display instructions may be formatted according to a specific host protocol such as telnet. An emulation module on the devices 124 and 350 may receive the display instructions and emulate them into another protocol (e.g., HTML) or modify (e.g., supplement, reorganize, suppress, etc.) the display instructions prior to being displayed on the devices 124 and 350. The distributed device 124 receives the display instructions from the host server 102.

Data related to the object 134 is captured (308) by the distributed device 124. For instance, an imaging device or camera of the distributed device 124 may photograph or otherwise scan the objects 134. The captured image data is processed (309) by the distributed device 124. For instance, the distributed device 124 includes a local LLM that is augmented by the adaptive profile. The captured data of the objects 134 are analyzed by the local LLM to determine a metric related to the objects 134 based on the captured image data. For instance, the photograph of the objects 134 might include six of the objects 134 stacked on a shelf. The local LLM augmented by the adaptive profile might identify the object 134 and determine that there are six of the objects 134. Additionally, the processing might include a determination of a location of the shelf. Some examples of the metric might include a count or a quantity determination, an identification determination, a location, another metric or some combination thereof.

The distributed device 124 may further process (311) the captured data using the adaptive profile to apply a derivative function to the determined metric. For instance, in some embodiments, the adaptive profile may include the derivative function that makes an additional determination based on the determined metric. An example of the derivative function is a restock function. The restock function is based on a threshold value below which a restock operation is triggered. The input to the restock function is the determined metric and the threshold may be set (e.g., input by the administrator 131) or determined based sales of the objects 134.

Responsive to the determined metric triggering the additional task, the distributed device 124 may communicate (310) a command function to the host server 102. For example, referring to the above example, the command function may include a message scheduling a restock task relative to the objects 134. Alternatively, the command function may be communicated to the cloud system 111 (such that it is assigned to the additional rugged device 350) or processed at the distributed device 124.

After the metric is determined, it may appear in the UI of the distributed device 124. For instance, when the determined metric is a count of the objects 134, a number might appear in the UI of the rugged device. The determined metric might be validated at the distributed device 124 by an operator. The captured data may be used as additional training information. For instance, the captured data might include another photograph, which is similar to the training information provided by the admin 131. Accordingly, the captured information might be used as the additional training information to refine operations of the local LLM.

The distributed device 124 communicates (316 and 314) the additional training information to one or both of the cloud system 111 and the admin device 114. The cloud system generates (317) an updated profile based on the adaptive profile and the additional training information. The additional training information modifies the data set of the adaptive profile to refine operation and analysis of the local LLM.

After the updated profile is generated, the distributed device 124 accesses (318) the updated profile from the cloud system 111 and implements the updated profile to modify the local LLM engine during inventory management operations conducted by the distributed device 124. For instance, the next time the distributed device 124 is in use, the updated profile may be accessed. The additional rugged device 350 accesses (320) the updated profile from the cloud system 111 and implements the updated profile to modify a local LLM engine during inventory management operations conducted by the additional rugged device 350.

FIG. 4 illustrates an example computer system 400 configured for profile-based LLM processing in inventory management environments, according to at least one embodiment of the present disclosure. The computer system 400 may be implemented in the operating environment 100 of FIG. 1, for instance. Examples of the computer system 400 may include the distributed device 124, the admin device 114, the cloud system 111, the host server 102, or some combination thereof. The computer system 400 may include one or more processors 410, a memory 412, a communication unit 414, a user interface device 416, and a data storage 402 that includes one or more or a combination of the console profile module 108, the cloud profile module 109, the inventory system 104, the AI engine 116, and client module 122 (collectively, system modules 450).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 402, or the memory 412 and the data storage 402. In some embodiments, the processor 410 may fetch program instructions from the data storage 402 and load the program instructions in the memory 412. After the program instructions are loaded into the memory 412, the processor 410 may execute the program instructions.

The memory 412 and the data storage 402 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network (e.g., the profile data storage 126 of FIG. 1).

The user interface device 416 may include one or more pieces of hardware configured to receive input from and/or provide output to a user. In some embodiments, the user interface device 416 may include one or more of a speaker, a microphone, a display, a keyboard, a touch screen, or a holographic projection, among other hardware devices.

The system modules 450 may include program instructions stored in the data storage 402. The processor 410 may be configured to load the system modules 450 into the memory 412 and execute the system modules 450. Alternatively, the processor 410 may execute the system modules 450 line-by-line from the data storage 402 without loading them into the memory 412. When executing the system modules 450, the processor 410 may be configured to perform one or more processes or operations described elsewhere in this disclosure.

Modifications, additions, or omissions may be made to the computer system 400 without departing from the scope of the present disclosure. For example, in some embodiments, the computer system 400 may not include the user interface device 416. In some embodiments, the different components of the computer system 400 may be physically separate and may be communicatively coupled via any suitable mechanism. For example, the data storage 402 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules.

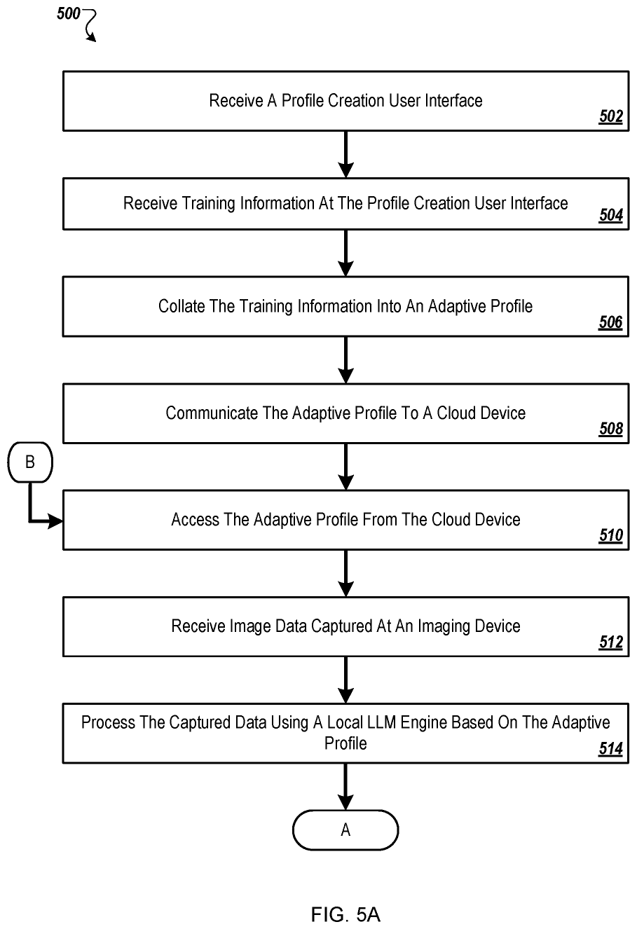

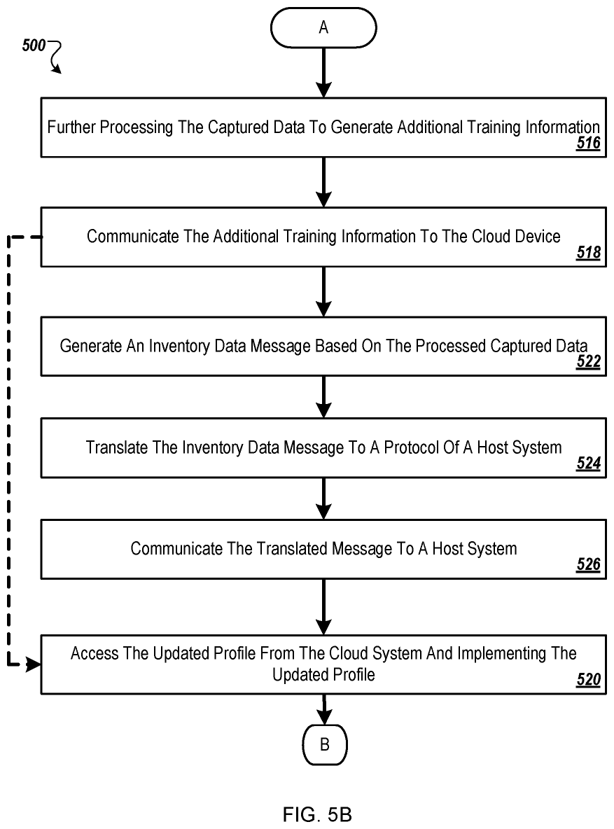

FIGS. 5A and 5B are a flowchart of an example method 500 for profile-based LLM processing in inventory management environments, in accordance at least one embodiment of the present disclosure. The method 500 may begin at block 502 in which a profile creation user interface may be received. The profile creation UI may be received at a first device such as the admin device 114 of FIGS. 1-2D. The profile creation user interface overlays a profile generation module such as the console profile module 108.

At block 504, training information is received at the profile creation UI. For instance, a user or an administrator such as the administrator 131 of FIGS. 1-2D may provide the training information to the admin device 114. At block 506, the training information is collated into an adaptive profile. In some embodiments, collation of the training information may be performed responsive to the training information. The adaptive profile includes a data set configured to direct output and decisions of an AI-based LLM. The adaptive profile is generated for a rugged device having local LLM functionality.

At block 508, the adaptive profile is communicated to a cloud device. For instance, the adaptive profile may be communicated from the admin device 114 to the cloud system 111 of FIG. 1. Communication of the adaptive profile is then remotely stored at the cloud device such that the adaptive profile is remotely accessible. At block 510, the adaptive profile may be accessed by a second device. For instance, a rugged device such as the distributed device 124 of FIGS. 1-2D may access the adaptive profile stored at the cloud device. After the adaptive profile is accessed, it is locally implemented such that the adaptive profile is used to modify the local LLM engine during inventory management operations.

At block 512, image data may be received at the second device. The image data may be captured at an imaging device of the second data. The image data includes an image of one or more objects in an inventory management environment. At block 514, the captured imaged data is processed using a local LLM engine (e.g., at the second device) based on the adaptive profile. For instance, the local LLM engine uses the adaptive profile to direct output of the local LLM engine. The processing includes a determination of a metric related to the objects. The determined metric might include identity of object(s), versions, prices, a count, a quantity determination of the number of the one or more objects in the captured image data.

At block 516, the captured data may be processed to generate additional training information. The additional training information is configured to modify the data set of the adaptive profile. At block 518, the additional training information may be communicated to the cloud device. The additional training information may be communicated to the cloud device such that the additional training information modifies the adaptive profile or the underlying data set to generate an updated profile.

For instance, training information may be a photograph (or digital representation thereof). The photograph might include ten boxes of soccer balls stacked in a triangle. The adaptive profile may be generated based on the photograph. Similarly, the captured data might include an additional photograph of boxes of soccer balls in the triangle from an angle. The captured data may be processed to determine the number of boxes of soccer balls. Additionally, the additional photograph might be used to modify the data set, which may improve accuracy of the local LLM in detecting the boxes of soccer balls.

At block 522 an inventory data message may be generated based on the processed captured data. For instance, the processed captured data may indicate a number of the objects, a location of the objects, a number of objects moved between locations, etc. The inventory data message is representative of the captured data. At block 524 the inventory data message may be translated to a protocol of a host system. For instance, the client module 122 may translate the inventory data message from an HTML protocol to a telnet protocol or otherwise format the inventory data message to a protocol utilized at the host system.

At block 526 the translated message may be communicated to the host system. The host system may include the host server 102 of FIGS. 1-2D. The translated messages is communicated to the host system such that data represented in the translated message are integrated into an inventory management database at the host system.

At block 520 the updated profile may be accessed. In some circumstances, the updated profile may be accessed by a third device from the cloud system. Additionally and alternatively, the updated profile may be accessed by the second device. For instance, at a later time (e.g., following communication of the additional training information), the second device may access the updated profile. After the updated profile is accessed, it is implemented modify a local LLM engine during inventory management operations.

The operations of blocks 516, 518, and 520 relate to adapting and updating the adaptive profile. In some implementations, the operations of block 520 might occur after block 518. For instance, the updated profile might be accessed by another device (e.g., the third device) at any time after the updated profile is accessible. In other implementations, the operations of block 520 might occur after the operations of block 526. For instance, when the second device accesses the updated profile, it might occur after the operations of block 526. In either case, after the updated profile is accessed, the operations of blocks 510, 512, 514, 516, 518, 520, 522, 524, 526, or some combination thereof may be repeated.

In some embodiments, the adaptive profile may include a derivative function. The derivative function may be defined using the profile creation module using the profile creation user interface. The derivative function is based on the determined metric or multiple determined metrics. For example, the derivative function might include a threshold value related to the determined metric that triggers an additional task. In these and other embodiments, the rugged device is configured to apply the derivative function to the determined metric. In some instances, the derivative function is applied during the processing of the captured data. In other instances, the derivative function is applied after the metric is determined.

Additionally, the derivative function may include a command function or be configured to generate a command related to the additional task. For instance, in addition to simply determining the metric, the adaptive profile may use the metric to initiate or implement an additional task. In some instances, the derivative function is configured to generate a command function for the additional task. Additionally, after the command function is generated, it may be communicated to one or both of the host server or the cloud device. In embodiments in which the derivative function includes a threshold, the command function generation and optional communication may be responsive to the determined metric exceeding a threshold value.

An example of the derivative function is a restocking function. In the restocking function, a threshold value may be defined that represents a minimum number of a particular object. The additional task includes a restocking task related to the object. Accordingly, in this example, when a number of the particular object falls below the threshold (which is a determined metric), then a restocking task is generated that indicates the particular object needs to be restocked.

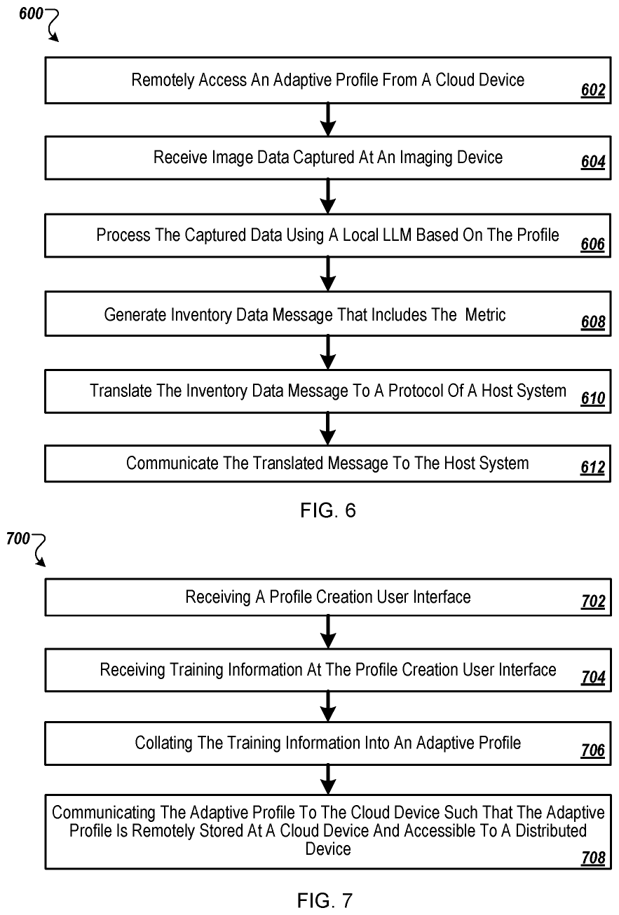

FIG. 6 is a flowchart of an example method 600 of adaptive profile augmentation to a LLM in an inventory management system. The method may begin at block 602 in which an adaptive profile is remotely accessed from a cloud device. For instance, the adaptive profile is remotely accessed by a rugged device (e.g., 124) from the cloud system 111. The adaptive profile includes a data set generated based on training information input in a profile module, which collates the training information into the data set. The adaptive profile directs output or results of an LLM or AI engine. The adaptive profile may also include a derivative function. The derivative function includes an additional task or output that is based on a determined metric that is output by the LLM or AI engine.

At block 604, image data is received. The image data may be captured at an imaging device or may be remotely input from an image device. The image data might include an image of one or more objects in an industrial environment or a portion of the industrial environment such as shelves, lockers, pallets as well as one or more objects. At block 606, the captured data is processed using a local LLM based on the adaptive profile. For instance, the captured data is analyzed by the local LLM to identify the objects and/or distinguish a number of the objects. The processing includes a determination of a metric related to the objects. The determined metric might include a count or a quantity determination of the number of objects in the image data, identification of the object, or combinations thereof. From the example above, the metric might include “six objects” “multiple object A,” “six of object A” “six of object A in location X”, and the like.

Additionally, in some embodiments, the processing using the adaptive profile might include application of the derivative function to the determined metric. For instance, the derivative function may include a threshold value that triggers an additional task. In these embodiments, responsive to the determined metric exceeding (or alternatively being less than) the threshold, a command function or an instruction may be generated for the additional task. The command function or the instruction may be integrated into an emulator module and/or communicated to one or both of the host server or the cloud device. The command function may schedule a task implemented in the inventory management system. For example, the determined metric may include a number of a particular object, and the derivative function generates a restocking task if fewer than five basketballs are on a particular shelf. In this example, the captured data may indicate that three basketballs are on the shelf. Responsive to there being three basketballs on the shelf, a command for a restocking task may be generated. The restocking task may be populated in the emulator module (e.g., 122) or in an inventory system (e.g., 104).

In some embodiments, the captured data may be further processed to generate additional training information. The additional training information is configured to modify the data set of the adaptive profile. The additional may be communicated to the cloud device such that the additional training information modifies the adaptive profile to generate an updated profile. The updated profile may take the place of the adaptive profile at the cloud device. For instance, after the update profile is generated at to the cloud device, the updated profile may be remotely accessed from the cloud device by one or more rugged devices such that additional processing of additional image data using the LLM may be augmented by the updated profile.

At block 608, an inventory data message may be generated based on the processed captured data. The inventory data message includes the metric or data representative of the metric. The operations of block 608 may be substantially similar to the operations of block 522 of FIG. 5B. At block 610, translating the inventory data message to a protocol of a host system. The operations of block 610 may be similar to the operations described with reference to block 524 of FIG. 5B. At block 612, the translated message may be communicated to the host system. As described with reference to block 526 of FIG. 5, the host system may include the host server 102 of FIGS. 1-2D and the translated messages are communicated such that data represented in the translated message are integrated into an inventory management database at the host system.

FIG. 7 is a flowchart of an example method 700 of adaptive profile generation in an inventory management system, according to at least one embodiment of the present disclosure. The method 700 may begin at block 702 in which a profile creation user interface is received. The profile creation user interface overlays a profile generation module such as the console profile module 108 of FIG. 1. For instance, the profile creation UI may include fields that accept training information as well as additional admin input used in the adaptive profile generation. In some embodiments, the profile creation UI may be received from a cloud device or may act as an interface between an admin device and a remote profile module remotely located.

At block 704, training information may be received at the profile creation user interface. In some embodiments, the profile creation UI further includes one or more forms that are configured to receive administrative input that describes the training information.

At block 706, responsive to the training information, the training information may be collated into an adaptive profile. The adaptive profile includes a data set configured to direct output and decisions of an AI-based LLM. The adaptive profile is generated for rugged devices having local LLM functionality. The training information includes image data input such as digital photograph, diagram, etc.

At block 708, the adaptive profile is communicated to the cloud device. The adaptive profile is stored at the cloud device such that it is remotely accessible at the cloud device and by one or more rugged devices. For instance, after the adaptive profile is stored at the cloud device, an operator of a rugged device may download the adaptive profile such that the adaptive profile can augment and direct operations of a local LLM operating on the rugged device. Moreover, one or more other rugged devices may also download the adaptive profile.

The methods 500-700 may be performed by one or more of the devices and systems described in the present disclosure such as the admin device 114, the cloud system 111, the host server 102, the distributed device 124, some combination thereof or by another suitable computing system, such as the computer system 400 of FIG. 4. In some embodiments, the devices and systems may include or may be communicatively coupled to a non-transitory computer-readable medium (e.g., the memory 412 of FIG. 4) having stored thereon programming code or instructions that are executable by one or more processors (such as the processor 410 of FIG. 4) to cause the devices or systems to perform or control performance of the methods 500-700. Additionally or alternatively, the devices and systems may include the processor 410 that is configured to execute computer instructions to cause the devices and systems to perform or control performance of the methods 500-700. The devices and systems implementing the methods 500-700 may be included in a cloud-based managed network, an on-premises system, or another suitable network computing environment. Although illustrated as discrete blocks, one or more blocks in FIGS. 5A-7 may be divided into additional blocks, combined into fewer blocks, or eliminated, depending on the desired implementation.

Further, modifications, additions, or omissions may be made to the methods 500-700 without departing from the scope of the present disclosure. For example, the operations of methods 500-700 may be implemented in differing orders. Furthermore, the outlined operations and actions are only provided as examples, and some of the operations and actions may be optional, combined into fewer operations and actions, or expanded into additional operations and actions without detracting from the disclosed embodiments.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system for profile-based large language model (LLM) processing in inventory management environments, the system comprising:
a host system including an inventory system;
a cloud device;
a rugged device including an imaging device, a local LLM engine, and an emulation module, wherein the rugged device is in network communication with the cloud device and the host system; and
an admin device including a profile creation module,
wherein:
the admin device is configured to:
receive a profile creation user interface, wherein the profile creation user interface overlays a profile generation module;
receive training information at the profile creation user interface;
responsive to the training information, collate the training information into an adaptive profile, the adaptive profile including data set configured to direct output and decisions of an artificial intelligence (AI)-based large language model (LLM) and being generated for a rugged device having local LLM functionality;
communicate the adaptive profile to the cloud device such that the adaptive profile is remotely stored at the cloud device and accessible to the rugged device;
the rugged device is configured to:
access the adaptive profile from the cloud device and implement the adaptive profile such that the adaptive profile is used to modify the local LLM engine during inventory management operations;
receive image data captured at the imaging device, the image data includes an image of one or more objects in the inventory management environment;
process the captured data using the local LLM engine based on the adaptive profile, the processing including a determination of a metric related to the objects;
the emulation module is configured to:
generate an inventory data message based on the processed captured data;
translate the inventory data message to a protocol of a host system; and
communicate the translated message to the host system; and
the host system is configured to communicate inventory screen data in the host protocol to the rugged device and to receive inventory messages in the host protocol from the rugged device.

2. The system of claim 1, wherein the rugged device is further configured to:
further process the captured data to generate additional training information, the additional training information is configured to modify the data set of the adaptive profile; and
communicate the additional training information to the cloud device such that the additional training information modifies the adaptive profile to generate an updated profile.

3. The system of claim 2, further comprising an additional rugged device including a local LLM engine, wherein the additional rugged device is configured to access the updated profile from the cloud device and implement the updated profile to modify the local LLM engine during inventory management operations conducted by the additional rugged device.

4. The system of claim 1, wherein the determined metric includes a count or a quantity determination of a number of the one or more objects in the image data.

5. The system of claim 4, wherein:
the adaptive profile includes a derivative function based on the determined metric; and
the rugged device is configured to apply the derivative function to the determined metric.

6. The system of claim 5, wherein the derivative function includes a threshold value related to the determined metric that triggers an additional task.

7. The system of claim 6, wherein the rugged device is configured to generate a command function for the additional task and communicate the command function to one or both of a host server or the cloud device responsive to the determined metric exceeding the threshold value of the derivative function.

8. The system of claim 7, wherein:
the derivative function includes a restocking function;
the threshold value represents a minimum number of the objects; and
the additional task includes a restocking task related to the object.

9. A method for profile-based large language model (LLM) processing in inventory management environments, the method comprising:
receiving, at a first device, a profile creation user interface, wherein the profile creation user interface overlays a profile generation module;
receiving, at the first device, training information at the profile creation user interface;
responsive to the training information, collating the training information into an adaptive profile, the adaptive profile including data set configured to direct output and decisions of an artificial intelligence (AI)-based large language model (LLM) and being generated for a second device having local LLM functionality;
communicating the adaptive profile to a cloud device such that the adaptive profile is remotely stored and accessible at the cloud device;
access, by a second device, the adaptive profile from the cloud device and implement the adaptive profile such that the adaptive profile is used to modify the local LLM engine during inventory management operations;
receiving image data captured at an imaging device, the image data includes an image of one or more objects in an inventory management environment;
processing the captured data using a local LLM engine based on the adaptive profile, the processing including a determination of a metric related to the objects;
generating an inventory data message based on the processed captured data;
translating the inventory data message to a protocol of a host system; and
communicating the translated message to a host system such that data represented in the translated message are integrated into an inventory management database at the host system.

10. The method of claim 9, further comprising
further processing the captured data to generate additional training information, the additional training information is configured to modify the data set of the adaptive profile; and
communicating the additional training information to the cloud device such that the additional training information modifies the adaptive profile to generate an updated profile.

11. The method of claim 10, further comprising accessing, by a third device, the updated profile from the cloud device and implementing the updated profile to modify a local LLM engine during inventory management operations conducted by the third device.

12. The method of claim 9, wherein the determined metric includes a count or a quantity determination of a number of the one or more objects in the image data.

13. The method of claim 12, wherein:
the adaptive profile includes a derivative function based on the determined metric; and
the second device is configured to apply the derivative function to the determined metric.

14. The method of claim 13, wherein the derivative function includes a threshold value related to the determined metric that triggers an additional task.

15. The method of claim 14, further comprising:
generating a command function for the additional task; and
communicating the command function to one or both of a host server or the cloud device responsive to the determined metric exceeding the threshold value of the derivative function.

16. The method of claim 15, wherein:
the derivative function includes a restocking function;
the threshold value represents a minimum number of the objects; and
the additional task includes a restocking task related to the object.

17. A method of adaptive profile generation in an inventory management system, the method comprising:
receiving a profile creation user interface, wherein the profile creation user interface overlays a profile generation module;
receiving training information at the profile creation user interface;
responsive to the training information, collating the training information into an adaptive profile, the adaptive profile including data set configured to direct output and decisions of an artificial intelligence (AI)-based large language model (LLM) and being generated for a rugged device having local LLM functionality; and
communicating the adaptive profile to a cloud device such that the adaptive profile is remotely stored at the cloud device and accessible to a rugged device.

18. The method of claim 17, wherein the training information includes image data input.

19. The method of claim 18, wherein the profile creation UI further includes a form configured to receive administrative input that describes the training information.

20. The method of claim 17, wherein the profile creation user interface is received from a cloud device on which a software as a service (SAAS) inventory management application is hosted.
